(19) United States
(12) Patent Application Publication
(10) Pub. No.: US 2025/0016259 A1
(43) Pub. Date: Jan. 9, 2025

(54) DISPLAY MODULE AND DISPLAY DEVICE

(71) Applicant: Hubei Yangtze Industrial Innovation Center Of Advanced Display Co., Ltd., Wuhan (CN)

(72) Inventors: Shengming LI, Wuhan (CN); Jiang CHEN, Wuhan (CN)

(21) Appl. No.: 18/815,879

(22) Filed: Aug. 27, 2024

(30) Foreign Application Priority Data
Mar. 14, 2024 (CN) 202410295921.9

(51) Int. Cl. H04M 1/02

(52) U.S. Cl. CPC H04M 1/0269

(57) ABSTRACT

Provided are a display panel and a display device, relating to the field of display technology and is used to reduce the possibility of forming wrinkles in a Quad-curved display screen. The display module includes a first bending region, a second bending region and a corner region. The corner region is located between the first bending region and the second bending region, and a bending direction of the first bending region is different from a bending direction of the second bending region. The display module includes: a display panel; and a support layer group. The support layer group at least includes a first support layer and a second support layer stacked in the corner region, the second support layer is located at a side of the first support layer away from the display panel, or located at a side of the first support layer close to the display panel.

### CROSS-REFERENCE TO RELATED APPLICATIONS

The present application claims priority to Chinese Patent Application No. 202410295921.9, filed on Mar. 14, 2024, the content of which is incorporated herein by reference in its entirety.

### TECHNICAL FIELD

The present disclosure relate to a flexible display module and a display device.

### BACKGROUND

With the development of the display technology and the improvement of user experience requirements on the display devices, a curved display screen, with which at least an edge of a display device can bend towards a back side of the display device, appears. The curved display screen can improve a screen-to-body ratio of the display device and improve the user experience.

Then, how to improve structural reliability of the curved display screen while increasing the screen-to-body ratio of the display device becomes a research focus of the skilled in the related art.

### SUMMARY

In view of this, the present disclosure provides a display module and a display device to improve the strength of the support layer group in the corner region between the first bending region and the second bending region in the display module, thereby improving the support effect of the support layer group on the display panel and enhancing the structural reliability of the display module.

In an aspect, an embodiment of the present disclosure provides a display module. The display module includes a first bending region, a second bending region and a corner region. The corner region is located between the first bending region and the second bending region, and a bending direction of the first bending region is different from a bending direction of the second bending region. The display module includes: a display panel; and a support layer group. The support layer group at least includes a first support layer and a second support layer stacked in the corner region, the second support layer is located at a side of the first support layer away from the display panel, or located at a side of the first support layer close to the display panel.

In another aspect, an embodiment of the present disclosure provides a display device including a display module. The display module includes a first bending region, a second bending region and a corner region. The corner region is located between the first bending region and the second bending region, and a bending direction of the first bending region is different from a bending direction of the second bending region. The display module includes: a display panel; and a support layer group. The support layer group at least includes a first support layer and a second support layer stacked in the corner region, the second support layer is located at a side of the first support layer away from the display panel, or located at a side of the first support layer close to the display panel.

According to the display module and the display device provided by the embodiments of the disclosure, the first bending region, the second bending region and the corner region are arranged in the display module, so that the display module can be used for a Quad-curved display screen, thereby narrowing a frame width of the display module, which is beneficial to improving the screen-to-body ratio of the display module and the user's visual experience.

In addition, in the embodiments of the present disclosure, the support layer group provided in the display module includes the first support layer and the second support layer that are stacked, so as to improve the strength of the support layer group in the corner region. Therefore, the first support layer and the second support layer can better support the display panel, thereby reducing the possibility of forming wrinkles in the support layer group during the bending process and after the reliability test. In this way, it reduces the possibility of forming wrinkles in the display panel located in the corner region and supported by the support layer group during the bending process and after the reliability test.

### BRIEF DESCRIPTION OF DRAWINGS

In order to better illustrate the technical solutions in the embodiments of the present disclosure, the drawings used in the description of the embodiments will be briefly illustrated as follows. It should be noted that, the drawings in the following description are merely some of, rather than all of the embodiments of the present disclosure. For those ordinarily skilled in the art, other drawings can be obtained in accordance with these drawings without any creative efforts.

FIG. 1 is a schematic diagram of a display module according to an embodiment of the present disclosure;

FIG. 2 is a schematic cross-sectional diagram of a display module according to an embodiment of the present disclosure;

FIG. 3 is a schematic cross-sectional diagram of another display module according to an embodiment of the present disclosure;

FIG. 4 is a schematic diagram of a position of a second support layer according to an embodiment of the present disclosure;

FIG. 5 is a schematic diagram of another second support layer according to an embodiment of the present disclosure;

FIG. 6 is a schematic diagram of another second support layer according to an embodiment of the present disclosure;

FIG. 7 is a schematic cross-sectional diagram of another second support layer according to an embodiment of the present disclosure;

FIG. 8 is a schematic diagram of another second support layer according to an embodiment of the present disclosure;

FIG. 9 is a schematic diagram of another second support layer according to an embodiment of the present disclosure; and

FIG. 10 is a schematic diagram of a display device according to an embodiment of the present disclosure.

### DESCRIPTION OF EMBODIMENTS

In order to better illustrate the technical solutions of the present disclosure, detailed description of embodiments of the present disclosure will be provided below in conjunction with the accompanying drawings.

It should be noted that the embodiments described are merely some of, rather than all of the embodiments of the present disclosure. Based on the described embodiments of the present disclosure, all other embodiments obtained by those ordinary skilled in the art without creative efforts shall fall within the protection scope of the present disclosure.

The terms used in the embodiments of the present disclosure are merely for the purpose of describing particular embodiments but not intended to limit the present disclosure. Unless otherwise noted in the context, the singular form expressions “a”, “an”, “the” and “said” used in the embodiments and appended claims of the present disclosure are also intended to represent plural form expressions thereof.

It should be understood that the term “and/or” used herein is merely an association relationship describing associated objects, indicating that there may be three relationships, for example, A and/or B may indicate that three cases, i.e., A existing individually, A and B existing simultaneously, B existing individually. In addition, the character “/” herein generally indicates that the related objects before and after the character form an “or” relationship.

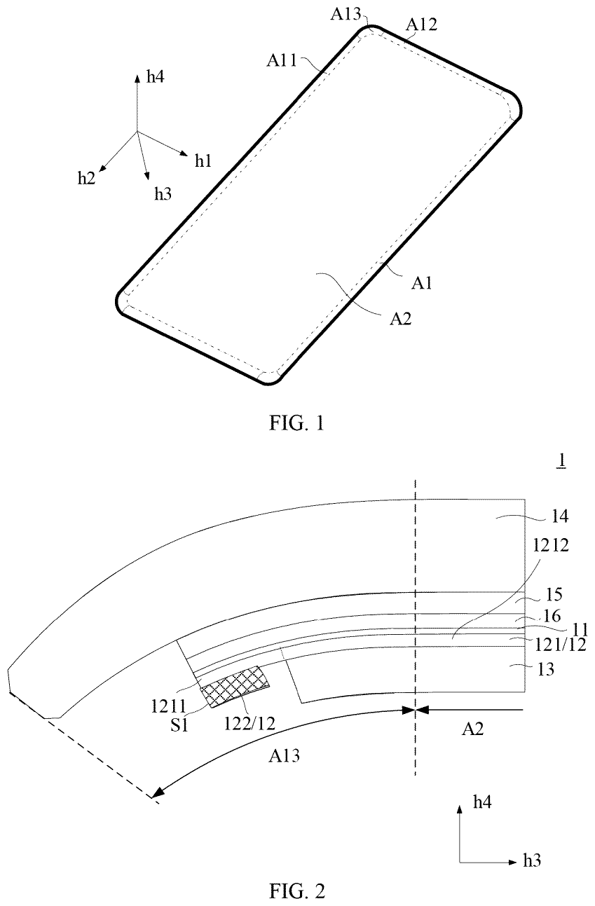

An embodiment of the present disclosure provides a display module, as shown in FIG. 1, which is a schematic diagram of a display module according to an embodiment of the present disclosure. The display module 1 has a first bending region A11, a second bending region A12, a corner region A13 located between the first bending region A11 and the second bending region A12, and a flat region A2. In an example, the corner region A13 is connected to the first bending region A11 and the second bending region A12. In an embodiment of the present disclosure, a bending direction of the first bending region A11 is different from a bending direction of the second bending region A12. The bending direction is perpendicular to an extending direction of a bending axis. As shown in FIG. 1, the first bending region A11 and the flat region A2 are arranged along a first direction h1, the second bending region A12 and the flat region A2 are arranged along a second direction h2, and the corner region A13 and the flat region A2 are arranged along the third direction h3. The first direction h1, the second direction h2, and the third direction h3 intersect with each other; and the first direction h1, the second direction h2, and the third direction h3 are all perpendicular to a fourth direction h4. The fourth direction h4 is perpendicular to a plane where the flat region A2 is located. A bending axis of the first bending region A11 intersects with the first direction h1, and a bending axis of the second bending region A12 intersects with the second direction h2. In an example, as shown in FIG. 1, the bending axis of the first bending region A11 is parallel to the second direction h2, the bending axis of the second bending region A12 is parallel to the first direction h1, and both the first bending region A11 and the second bending region A12 are bent towards a direction away from a light-exit side of the display panel.

In an example, as shown in FIG. 2, which is a schematic cross-sectional diagram of a display module according to an embodiment of the present disclosure, the display module 1 includes a display panel 11 and a support layer group 12. In an example, the display panel 11 includes a flexible display panel, that is, the display panel 11 may be deformed such as bent to present different spatial forms.

Exemplarily, the display panel 11 may extend from the flat region A2 to the first bending region A11 along the first direction h1, and may extend from the flat region A2 to the second bending region A12 along the second direction h2, and may extend from the flat region A2 to the corner region A13 along the third direction h3.

In an example, the display module 1 has a display region and a frame region. The display region includes the flat region A2.

In an embodiment of the present disclosure, the display panel 11 can be a Quad-curved display screen. The Quad-curved display screen refers to a curved screen which includes bended left and right edges of the flat region A2 as well as bended upper and lower edges, that is, the Quad-curved display screen includes respective curved surfaces at upper, lower, left and right edges of the flat screen. In an example, the display region further includes at least a partial region close to the flat region A2 from the first bending region A11, the second bending region A12 and the corner region A13. Compared with a double-curved display screen, the Quad-curved display screen has a higher screen-to-body ratio.

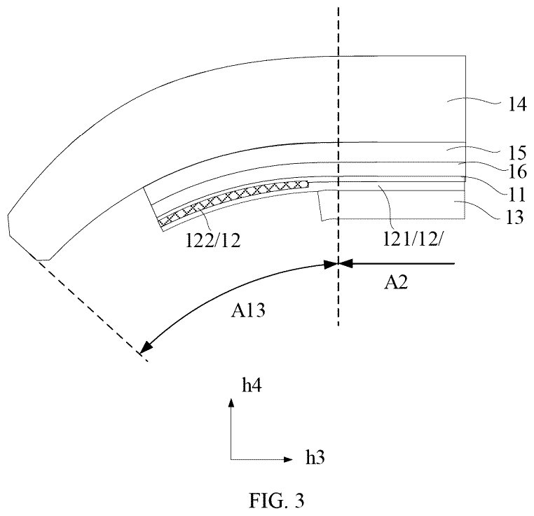

In an example, as shown in FIG. 2, the support layer group 12 includes a first support layer 121 and a second support layer 122 that are stacked. As shown in FIG. 2, the second support layer 122 is located at a side of the first support layer 121 away from the display panel 11. Alternatively, as shown in FIG. 3, which is a schematic cross-sectional diagram of another display module according to an embodiment of the present disclosure, the second support layer 122 is located at a side of the first support layer 121 close to the display panel 11.

In an embodiment of the present disclosure, at least part of the first support layer 121 and the second support layer 122 is located in the corner region A13. In an example, as shown in FIG. 2 and FIG. 3, part of the first support layer 121 is located in the corner region A13, and all of the second support layer 122 is located in the corner region A13.

According to the display module 1 provided in the embodiments of the present disclosure, the first bending region A11, the second bending region A12, and the corner region A13 are arranged in the display module 1, so that the display module 1 can be used for a Quad-curved display screen, which is beneficial to improving the screen-to-body ratio of the display module 1, and thus making the display module 1 more aesthetic and improving the user's visual experience.

As shown in FIG. 1, since the bending direction of the first bending region A11 is different from the second bending region A12, the corner region A13 located between the first bending region A11 and the second bending region A12 and connected thereto respectively are actually regions having a composite curvature in the display module 1. Different from the first bending region A11 and the second bending region A12 each having a single bending direction, the corner region A13 having a composite curvature will be subjected to a combined effect of the bending stress in different bending directions, resulting in forming wrinkles at a certain portion of the display panel 11 located in the corner region A13. In the thickness direction of the display panel 11, the wrinkle portion protrudes from a portion where no wrinkle is formed. The wrinkle not only affects the appearance of the display panel 11, but also causes non-tight fitness between the display panel 11 and another film layer located at a front/back surface of the display panel 11, thereby affecting the reliability of the product. In the embodiments of the present disclosure, the support layer group 12 is provided in the display module 1, and the support layer group 12 includes the first support layer 121 and the second support layer 122 that are stacked, so that the first support layer 121 and the second support layer 122 can together support the display panel 11. Compared with the arrangement of the support layer group 12 as a single-layer structure, the strength of the support layer group 12 in the corner region A13 can be improved based on the arrangement according to the embodiments of the present disclosure. When there is a deformation tendency of forming wrinkles at a portion of the display panel 11 located in the corner region A13, the support layer group 12 can apply a force against the deformation which may lead to forming wrinkles, thereby decreasing the possibility that the display panel 11 has a convex deformation along the thickness direction in the corner region A13. That is, the first support layer 121 and the second support layer 122 can better support the display panel 11, thereby reducing the possibility of wrinkling in the display panel 11 located in the corner region A13 and supported by the support layer group 12 during the bending process and after the reliability test.

Exemplarily, in an embodiment of the present disclosure, the elastic modulus of the second support layer 122 is greater than or equal to that of the first support layer 121. In an embodiment of the present disclosure, the strength of the support layer group 12 can be improved by setting the elastic modulus of the second support layer 122 to be larger, and the support layer group 12 having the higher strength can provide a larger support force on the display panel 11 along the thickness direction of the display panel 11, which is beneficial to further improving the support effect of the support layer group 12 on the display panel 11. When there is a deformation tendency of forming wrinkles at the portion of the display panel 11 located in the corner region A13, the support layer group 12 can apply a force against the deformation which may lead to forming wrinkles, thereby reducing the possibility of forming wrinkles in the display module 1 in the corner region A13.

In an example, as shown in FIG. 2 and FIG. 3, the display module 1 further includes a buffer layer 13. The buffer layer 13 can absorb the external stress, thereby reducing the possibility of deformation of the display module 1 under the impact of an external force, and protecting the display module 1. Moreover, the buffer layer 13 and the support layer group 12 can support the display panel 11 together to further protect the display panel 11. In an example, the buffer layer 13 includes super clean foam (SCF). Exemplarily, the elastic modulus of the buffer layer 13 is less than or equal to that of the first support layer 121 and the second support layer 122.

Exemplarily, as shown in FIG. 2, in an embodiment of the present disclosure, both the second support layer 122 and the buffer layer 13 care located at a side of the first support layer 121 away from the display panel 11. In an embodiment of the present disclosure, the thickness of the second support layer 122 is less than or equal to that of the buffer layer 13. FIG. 2 illustrates that the thickness of the second support layer 122 is smaller than that of the buffer layer 13. Based on this arrangement, the buffer layer 13 can first have a buffering effect to the external force to prevent the external force from directly acting on the second support layer 122 when there is an external force.

In an example, as shown in FIG. 2, an area of the first support layer 121 is greater than an area of the second support layer 122, and the area of the first support layer 121 is greater than an area of the buffer layer 13. Exemplarily, as shown in FIG. 2, the first support layer 121 includes a first portion 1211 and a second portion 1212, the second support layer 122 is in contact with the first portion 1211, and the buffer layer 13 is in contact with the second portion 1212.

Exemplarily, as shown in FIG. 2, the second portion 1212 is located at a side of the first portion 1211 close to the flat region A2. As shown in FIG. 2, the buffer layer 13 is in contact with the second portion 1212, that is, the buffer layer 13 retracts inward relative to the first support layer 121. The inward retraction herein means that the buffer layer 13 is retracted, relative to the first support layer 121, towards a direction close to the flat region A2. The second support layer 122 is located in a retracted region of the buffer layer 13 relative to an edge of the first support layer 121. In the embodiments of the present disclosure, the area of the buffer layer 13 is set to be smaller than that of the first support layer 121, and the buffer layer 13 is set to be retracted inward relative to the first support layer 121. In this case, when the display module 1 is used in an electronic device such as a mobile phone, the buffer layer 13 can be prevented from protruding from the first support layer 121, and avoiding conflicts between the buffer layer 13 and other components in the electronic device. Moreover, the requirement for the fitness accuracy of the buffer layer 13 and the first support layer 121 can be reduced by adopting the above-mentioned arrangement, which is beneficial to reducing the process difficulty and improving the process efficiency. On this basis, in an embodiment of the present disclosure, the second support layer 122 is arranged at a retracted position of the buffer layer 13 relative to the first support layer 121, and the second support layer 122 can be arranged by using an existing space in the display module 1. Compared with an arrangement manner in which the second support layer 122 and the buffer layer 13 are stacked, the arrangement according to this embodiment of the present disclosure can reduce the thickness of the display module 1 while using the buffer layer 13 to absorb the external stress.

In an example, a length L1 of the first portion 1211 satisfies: 0.3 mm≤L1≤0.5 mm. A length direction of the first portion 1211 is parallel to an arrangement direction in which the first portion 1211 and the second portion 1212 are arranged.

Exemplarily, as shown in FIG. 2, the second support layer 122 includes a first edge S1, which is flush with an edge of the display panel 11 away from the flat region A2. With this arrangement, while increasing an area of the second support layer 122 for supporting the display panel 11, it avoids that the first edge S1 of the second support layer 122 is beyond the display panel 11. In this case, when the display module 1 is used for an electronic device such as a mobile phone, it can avoid conflicts between the second support layer 122 and other structure outside of the display module 1 in the electronic device.

Exemplarily, when forming the display module 1, the second support layer 122 having a larger area can be first fitted to a side of the display panel 11 away from the light-exit side, and then the second support layer 122 and the display panel 11 are integrally cut, to make the first edge S1 be flush with an edge of the display panel 11 away from the flat region A2. Alternatively, in an embodiment of the present disclosure, the second support layer 122, initially in a glue state, can be first coated on a side of the display panel 11 away from the light-exit side, and then the glue is cured, and during glue coating process, the edge of the glue is controlled to be flush with the edge of the side of the display panel 11 away from the flat region A2.

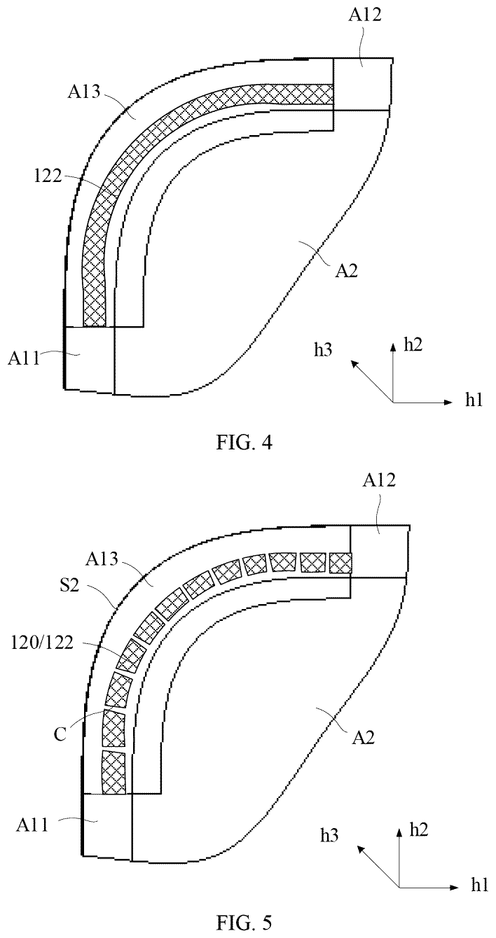

Exemplarily, as shown in FIG. 2, FIG. 3 and FIG. 4, FIG. 4 is a schematic diagram of a position of a second support layer according to an embodiment of the present disclosure, and the second support layer 122 is only arranged in the corner region A13. That is, the second support layer 122 is not arranged in the first bending region A11, the second bending region A12, and the flat region A2. In the process of bending the first bending region A11 and the second bending region A12 relative to the flat region A2 and after bending, based on this arrangement manner, it can avoid that the second support layer 122 is affected by deformation at other regions, such as the first bending region A11 and the second bending region A12. In this way, the second support layer 122 can be freely deformed in the corner region A13, thereby avoiding forming wrinkles in the second support layer 122, and thus further improving the support effect of the support layer group 12 on the display panel 11 during the bending process and after bending, and reducing the possibility of forming wrinkles in the display panel 11. In addition, in the embodiments of the present disclosure, the second support layer 122 is only arranged in the corner region A13. Compared with that the second support layer 122 is also arranged in the first bending region A11 or the second bending region A12 or the flat region A2, an area of the second support layer 122 can be reduced, thereby decreasing the manufacturing cost of the display module 1. In addition, the overall thickness of the first bending region A11 or the second bending region A12 or the flat region A2 can be reduced, which is beneficial to light and thin design of the display module 1.

In an example, the second support layer 122 includes an organic material. Exemplarily, the organic material includes a glue layer or PET.

Alternatively, in the embodiments of the present disclosure, the second support layer 122 may include metal, thereby increasing the strength of the support layer group 12 including the second support layer 122, and thus improving the support effect of the display panel 11 and reducing the possibility of forming wrinkles in the display panel 11 after bending.

Exemplarily, when the second support layer 122 is made of metal, the thickness d of the second support layer 122 may satisfy: 10 μm≤d≤20 μm. In the embodiments of the present disclosure, the second support layer 122 can have sufficient strength by setting d≥10 μm, so as to apply a force to the display panel 11 along the thickness direction of the display panel 11 by using the second support layer 122 having sufficient strength. That is, in this way, the second support layer 122 can better support the display panel 11 to suppress forming wrinkles in the display panel 11. In addition, in the embodiments of the present disclosure, the thickness of the second support layer 122 can be prevented from being too large by setting d≤20 μm, so that the second support layer 122 can be bent along with the bending of the corner region A13 in the display panel 11 while ensuring the support effect of the second support layer 122 on the display panel 11. In this way, the second support layer 122 can be better fitted to the display panel 11. In addition, in the embodiments of the present disclosure, the overall thickness of display module 1 can be reduced by setting d≤20 μm, thereby being beneficial to light and thin design of the display module 1.

In an example, as shown in FIG. 5, which is a schematic diagram of another second support layer according to an embodiment of the present disclosure, the second support layer 122 may include a plurality of sub-support layers 120, and two adjacent sub-support layers 120 of the plurality of sub-support layers 120 may be spaced from each other. With this arrangement, on the one hand, a gap between two adjacent sub-support layers 120 can be used as a stress-relief groove, so that the stress generated during the bending process is released by the stress-relief groove, thereby further improving the strength of the second support layer 122; and on the other hand, a gap between two adjacent sub-support layers 120 can prevent deformation of the sub-support layer 120 from being affected by other portions during the bending process, thereby reducing the possibility of forming wrinkles in the sub-support layer 120, and making the sub-support layer 120 more easily fitted to the display panel 11.

Exemplarily, as shown in FIG. 2 and FIG. 3, the display module 1 may further include a cover plate 14, an optical glue 15, and a polarizer 16. The polarizer 16, the optical glue 15 and the cover plate 14 are sequentially stacked at a side of the display panel 11 away from the support layer group 12. The polarizer 16 is configured to adjust a polarization state of the light. The cover plate 14 is configured to protect the display panel 11. The optical glue 15 is used to bond the polarizer 16 and the cover plate 14.

In an example, according to an embodiment of the present disclosure, when forming the display module 1, a Quad-curved cover plate 14 may be first provided, and then the display panel 11 and the support layer group 12, which are fitted to each other and in a flattened state, are fitted to the cover plate 14 for bending. In the embodiments of the present disclosure, the second support layer 122 includes a plurality of sub-support layers 120, which not only facilitates the fitness of the second support layer 122 to the cover plate 14, but also facilitates the release of the stress of the second support layer 122 during the bending process, thereby reducing the possibility of wrinkling of the second support layer 122.

In the related art, when forming a Quad-curved display screen, a portion of the display panel 11 corresponding to a corner region of the cover plate 14 having a composite curvature is usually removed, that is, the display panel 11 does not enter the corner region of the cover plate 14 having the composite curvature, so as to avoid defects such as wrinkles at a portion of the display panel 11 corresponding to the corner region caused by uneven stress. As a result, with this arrangement in the related art, the display panel 11 cannot be displayed at a position corresponding to the corner region. By adopting the arrangement manner provided by the embodiments of the disclosure, the portion of the display panel 11 corresponding to the corner region does not need to be removed, so that the display effect at the corner region can be achieved while avoiding forming wrinkles in the display panel 11.

In an example, as shown in FIG. 5, the display module 1 includes a second edge S2 at a side away from the flat region A2. A cut line C between adjacent sub-support layers 120 is perpendicular to a tangent of the second edge S2 at the corresponding position. In an example, the sub-support layers 120 can be obtained by cutting a large-area second support layer 122, and an edge of the sub-support layer 120 close to another sub-support layer 120 is a cut line C between adjacent sub-support layers 120. In the process of bending the first bending region A1 and the second bending region A2, the composite stress of the display module 1 in the direction perpendicular to the tangent of the second edge S2 is relatively large. In the embodiments of the present disclosure, the cut line C between adjacent sub-support layers 120 is perpendicular to the tangent of the second edge S2 of the display module 1 at the corresponding position, so that the originally large bending stress can be released at the position of the cut line C, thereby being beneficial to improving the strength of the second support layer 122 and reducing the possibility of cracks in the second support layer 122. In addition, in an embodiment of the present disclosure, the bending stress at different positions of the corner region A13 gradually increases along a direction from the corner region A13 towards the flat region A2. As shown in FIG. 5, the second edge S2 has an arc shape. In the embodiments of the present disclosure, the cut line C between adjacent sub-support layers 120 is perpendicular to the tangent of the second edge S2 at the corresponding position, then the sub-support layers 120 at different positions can each have an approximately fan-like shape. That is, a width of the sub-support layer 120 decreases along a direction from the corner region A13 towards the flat region A2, thereby making deformation at different positions of a same sub-support layer 120 more free in the direction from the corner region A13 towards the flat region A2. With this arrangement, the width of the sub-support layer 120 can be adapted to the bending stress of the sub-support layer 120 at different positions. In this way, the sub-support layer 120 has a smaller width at a position corresponding to a larger stress, thereby allowing the sub-support layer 120 at this position to deform more flexibly, and thus reducing the possibility of wrinkling.

Exemplarily, as shown in FIG. 5, the width of the sub-support layer 120 is greater than a distance between two adjacent sub-support layers 120, and a width direction of the sub-support layer 120 is parallel to an arrangement direction in which two adjacent sub-support layers 120 are arranged. In an embodiment of the present disclosure, by making the width of the sub-support layer 120 greater than the distance between two adjacent sub-support layers 120, the second support layer 122 can have a sufficient area for supporting the display panel 11 while releasing the stress of the sub-support layer 120 during the bending process and improving the degree of freedom of deformation, thereby ensuring the support effect of the second support layer 122 on the display panel 11.

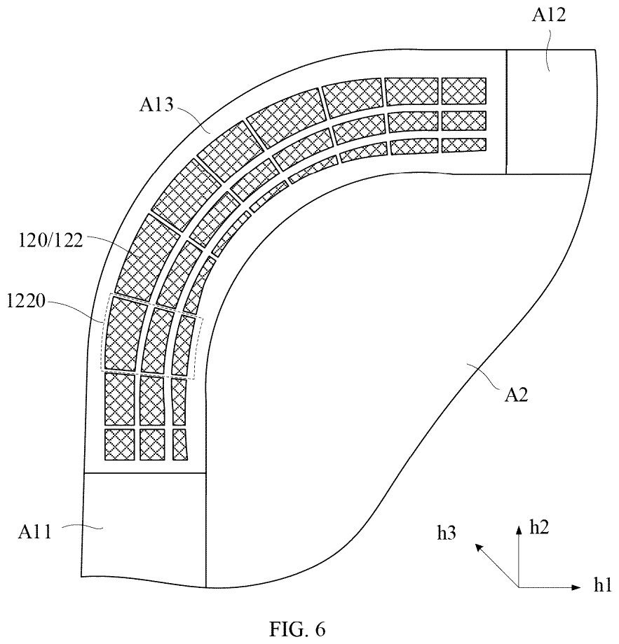

In an example, as shown in FIG. 6, which is a schematic diagram of another second support layer according to an embodiment of the present disclosure, the area of the sub-support layer 120 decreases along a direction from the edge region A13 towards the flat region A2. The bending stress at different positions in the corner region A13 increases along the direction from the corner region A13 towards the flat region A2. Moreover, the smaller the area of the sub-support layer 120 is, the higher the degree of freedom of deformation is. That is, the lower the possibility of being affected during deformation is, and the lower the possibility of forming wrinkles. In the embodiments of the present disclosure, the area of the sub-support layer 120 decreases along the direction from the corner region A13 towards the flat region A2, so that the area of the sub-support layer 120 can be adapted to the bending stress of the sub-support layer 120 at different positions. The sub-support layer 120 has a smaller area at a position with a larger stress, to allow the sub-support layer 120 at this position to deform more flexibly, thereby reducing the possibility of wrinkling. The sub-support layer 120 has a larger area at a position with a smaller stress, and the sub-support layer 120 at this position can be used to sufficiently support the display panel 11, to allow the display module 1 to have a higher strength.

In an example, the width of the sub-support layer 120 decreases along the direction from the edge region A13 towards the flat region A2, and/or the length of the sub-support layer 120 decreases along the direction from the edge region A13 towards the flat region A2, so that the area of the sub-support layer 120 decreases along the direction from the edge region A13 towards the flat region A2.

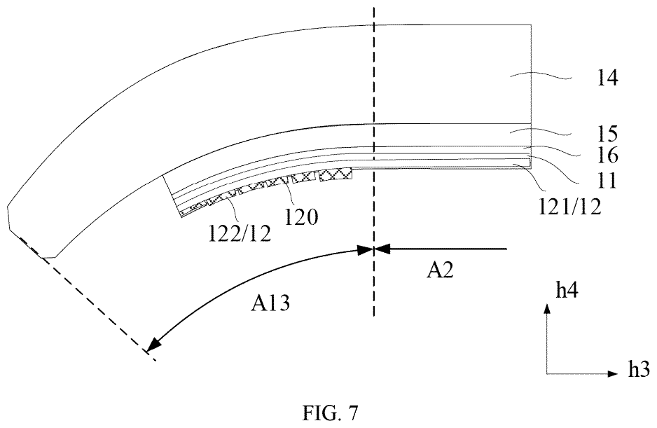

In an example, as shown in FIG. 7, which is a schematic cross-sectional view of another second support layer according to an embodiment of the present disclosure, the thickness of the sub-support layer 120 increases along the direction from the edge region A13 towards the flat region A2.

The bending stress at different positions in the corner region A13 increases along the direction from the corner region A13 towards the flat region A2. Moreover, the larger the thickness of the sub-support layer 120, the stronger the support effect of the sub-support layer 120 on the display panel 11. When there is a tendency of forming wrinkles at a position in the corner region A13 of the display panel 11, the sub-support layer 120 with a larger thickness has a higher strength, and there is a larger force applied to the display panel 11 to suppress forming wrinkles, making it less likely to form wrinkles at this position. In the embodiments of the present disclosure, the thickness of the sub-support layer 120 increases along the direction from the corner region A13 towards the flat region A2, so that the sub-support layer 120 at a position with a relatively large stress has a relatively large thickness, and the sub-support layer 120 at a position with a relatively small stress has a relatively small thickness. In this way, the support effect of the sub-support layer 120 can be adapted to the composite stress at the position where the sub-support layer 120 is located, thereby avoiding excessively large thickness of the sub-support layer 120 at the position with a relatively small stress to cause redundancy of the thickness of the sub-support layer 120, and avoiding excessively small thickness of the sub-support layer 120 at the position with a relatively large stress to cause insufficient support effect to affect the strength of the display module 1, which would lead to forming wrinkles at this position of the display module 1.

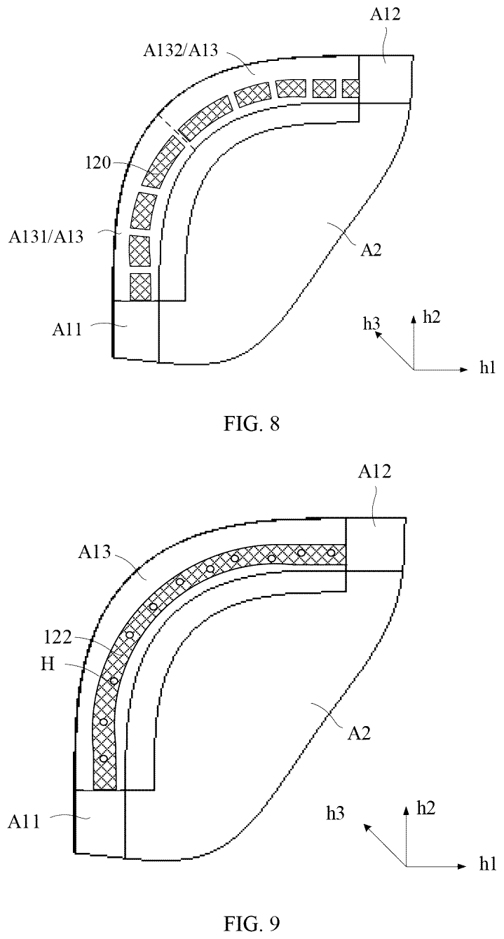

Exemplarily, the area of the sub-support layer 120 decreases along the direction from the corner region A13 towards the first bending region A11, and/or along the direction from the corner region A13 towards the second bending region A12. As shown in FIG. 8, which is a schematic diagram of another second support layer according to an embodiment of the present disclosure, the corner region A13 includes a first sub-corner region A131 and a second sub-corner region A132, the first sub-corner region A131 is located at a side of the second sub-corner region A132 close to the first bending region A11, and the second sub-corner region A132 is located at a side of the first sub-corner region A131 close to the second bending region. In the first sub-corner region A131, the area of the sub-support layer 120 decreases along the direction from the corner region A13 towards the first bending region A11. In the second sub-corner region A132, the area of the sub-support layer 120 decreases along the direction from the corner region A13 towards the second bending region A12. The closer to the first bending region A11 or the second bending region A12, the smaller the composite bending stress applied to the sub-support layer 120 during the bending process. Therefore, in some embodiments of the present disclosure, as shown in FIG. 8, the area of the sub-support layer 120 decreases along the direction from the corner region A13 towards the first bending region A11, so that the area of the sub-support layer 120 can be adapted to the composite bending stress at different positions. The sub-support layer 120 has a smaller area at a position with a larger stress, to allow the sub-support layer 120 at this position to deform more flexibly, thereby reducing the possibility of wrinkling; and the sub-support layer 120 has a relatively large area at a position with a relatively small stress, to allow the sub-support layer 120 at this position to have a sufficient support effect on the display panel 11, so that the display module 1 can have a relatively high strength, thereby avoiding redundancy of the area of the sub-support layer 120 to cause a problem that the sub-support layer 120 cannot be deformed flexibly, or avoiding insufficiency of the area of the sub-support layer 120 to cause a problem that the sub-support layer 120 has an insufficient support effect. And/or, in some embodiments of the present disclosure, the area of the sub-support layer 120 decreases along the direction from the corner region A13 towards the second bending region A12, so that the area of the sub-support layer 120 can be adapted to the composite bending stress at different positions, thereby avoiding redundancy of the area of the sub-support layer 120 to cause a problem that the sub-support layer 120 cannot be deformed flexibly, or avoiding insufficiency of the area of the sub-support layer 120 to cause a problem that the sub-support layer 120 has an insufficient support effect.

Exemplarily, the thickness of the sub-support layer 120 decreases along a direction from the corner region A13 towards the first bending region A11 and/or along a direction from the corner region A13 towards the second bending region A12. The closer to the first bending region A11 or the second bending region A12, the smaller the composite bending stress applied to the sub-support layer 120 during the bending process. Therefore, in some embodiments of the present disclosure, the thickness of the sub-support layer 120 decreases along the direction from the corner region A13 towards the first bending region A11, so that the sub-support layer 120 has a larger thickness at a position with the larger stress and has a smaller thickness at a position with the smaller stress. That is, the thickness of the sub-support layer 120 can be adapted to the composite stress at different positions, thereby avoiding redundancy of the thickness of the sub-support layer 120 at a position with a relatively small stress, and avoiding insufficiency of the thickness of the sub-support layer 120 at a position with a relatively large stress to cause a problem that the sub-support layer 120 has an insufficient support effect to affect the strength of the display module 1, which would lead to forming wrinkles at this position of the display module 1.

In an example, as shown in FIG. 6, the second support layer 122 includes a plurality of sub-support layer groups 1220, which are arranged in the direction of the corner region A13 towards the first bending region A11 or the second bending region A12. The sub-support layer groups 1220 include a plurality of sub-support layers 120 arranged in the direction of the flat region A2 towards the corner region A13. The arrangement of the sub-support layer group 1220 can increase the number of the sub-support layers 120 in the second support layer 122, which is beneficial to further increase the degree of freedom of deformation of the second support layer 122.

Exemplarily, as shown in FIG. 9, which is a schematic diagram of another second support layer according to an embodiment of the present disclosure, the second support layer 122 includes openings H. The opening H can be used as a stress-release hole, which can improve the strength of the second support layer 122 and improve the support effect of the second support layer 122 on the display panel 11, thereby reducing the possibility of wrinkling of the second support layer 122, and thus reducing the possibility of wrinkling of the display panel 11. In an example, the opening H passes through the second support layer 122

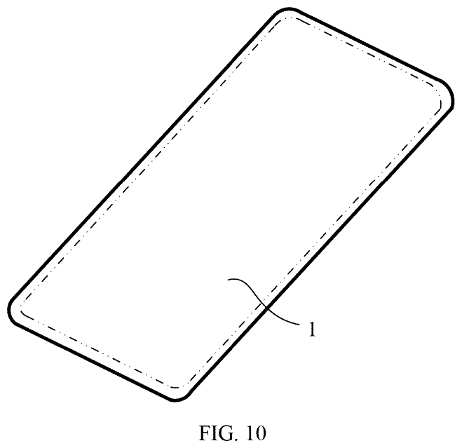

An embodiment of the present disclosure provides a display device, as shown in FIG. 10, which is a schematic diagram of a display device including the above display module 1 according to an embodiment of the present disclosure. A specific structure of the display module 1 has been described in details in the above-described embodiments, and will not be further described herein. It should be noted that the display device shown in FIG. 10 is merely illustrative, and the display device may be any electronic device with a display function, such as a cellphone, a tablet, a laptop, an e-paper book, or a television.

According to the display device provided by the embodiments of the present disclosure, the first bending region, the second bending region and the corner region are provided in the display module 1, so that the display module 1 can be used for a Quad-curved display screen, which is beneficial to improving the screen-to-body ratio of the display module 1, and thus making the display module 1 more aesthetic and improving the user's visual experience.

In addition, in the embodiments of the present disclosure, the support layer group is provided in the display module, and the support layer group includes the first support layer and the second support layer that are stacked, so that the first support layer and the second support layer can support the display panel together, thereby improving the strength of the support layer group in the corner region. Therefore, the first support layer and the second support layer can better support the display panel, thereby reducing the possibility of forming wrinkles in the support layer group during the bending process and after the reliability test, and thus reducing the possibility of forming wrinkles in the display panel located in the corner region and supported by the support layer group during the bending process and after the reliability test.

The above descriptions are merely preferred embodiments of the present disclosure and are not intended to limit the present disclosure. It should be noted that any modifications, equivalent substitutions, improvements, and the like made within a concept of the present disclosure shall fall within a scope of the present disclosure.

What is claimed is:

1. A display module, comprising a first bending region, a second bending region and a corner region, wherein the corner region is located between the first bending region and the second bending region, and a bending direction of the first bending region is different from a bending direction of the second bending region,
wherein the display module comprises:
a display panel; and
a support layer group,
wherein the support layer group at least comprises a first support layer and a second support layer stacked in the corner region, the second support layer is located at a side of the first support layer away from the display panel, or located at a side of the first support layer close to the display panel.

2. The display module according to claim 1, wherein elastic modulus of the second support layer is greater than or equal to elastic modulus of the first support layer.

3. The display module according to claim 1, further comprising a buffer layer,
wherein the second support layer and the buffer layer are both located at a side of the first support layer away from the display panel, and a thickness of the second support layer is less than or equal to a thickness of the buffer layer,
wherein the first support layer comprises a first portion in contact with the second support layer, and a second portion in contact with the buffer layer.

4. The display module according to claim 3, further comprising a flat region, wherein the second portion is located at a side of the first portion close to the flat region.

5. The display module according to claim 1, further comprising a flat region, wherein the second support layer comprises a first edge flush with an edge of the display panel away from the flat region.

6. The display module according to claim 1, wherein the second support layer comprises an organic material.

7. The display module according to claim 1, wherein the second support layer is arranged only in the corner region.

8. The display module according to claim 1, wherein the second support layer comprises metal.

9. The display module according to claim 8, wherein a thickness d of the second support layer satisfies: 10 μm≤d≤20 μm.

10. The display module according to claim 1, wherein the second support layer comprises a plurality of sub-support layers, and two adjacent sub-support layers of the plurality of sub-support layers are spaced from each other.

11. The display module according to claim 10, further comprising a flat region, wherein the display module comprises a second edge located at a side away from the flat region; and a cut line between two adjacent sub-support layers is perpendicular to a tangent of the second edge at a position corresponding to the two adjacent sub-support layers.

12. The display module according to claim 10, wherein a width of the sub-support layer is greater than a distance between two adjacent sub-support layers, and a width direction of the sub-support layer is parallel to an arrangement direction along which the two adjacent two sub-support layers are arranged.

13. The display module according to claim 10, further comprising a flat region, wherein an area of the sub-support layer decreases along a direction from the corner region towards the flat region.

14. The display module according to claim 10, further comprising a flat region, wherein a thickness of the sub-support layer increases along a direction from the corner region towards the flat region.

15. The display module according to claim 10, wherein an area of the sub-support layer decreases along a direction from the corner region towards the first bending region and/or decreases along a direction from the corner region towards the second bending region.

16. The display module according to claim 10, wherein a thickness of the sub-support layer decreases along a direction from the corner region towards the first bending region and/or along a direction from the corner region towards the second bending region.

17. The display module according to claim 10, further comprising a flat region, wherein the second support layer comprises a plurality of sub-support layer groups, and one of the plurality of sub-support layer groups comprises a plurality of sub-support layers arranged along a direction from the flat region to the corner region.

18. The display module according to claim 1, wherein the second support layer comprises a plurality of openings.

19. A display device, comprising a display module comprising a first bending region, a second bending region and a corner region, wherein the corner region is located between the first bending region and the second bending region, and a bending direction of the first bending region is different from a bending direction of the second bending region,
wherein the display module comprises:
a display panel; and
a support layer group,
wherein the support layer group at least comprises a first support layer and a second support layer stacked in the corner region, the second support layer is located at a side of the first support layer away from the display panel, or located at a side of the first support layer close to the display panel.
